(19) United States
(12) Patent Application Publication
(10) Pub. No.: US 2023/0337881 A1
(43) Pub. Date: Oct. 26, 2023

(54) ROBOT CLEANER AND ROBOT CLEANING SYSTEM INCLUDING THE SAME

(71) Applicant: LG ELECTRONICS INC., Seoul (KR)

(72) Inventors: Yonggil SHIN, Seoul (KR); Hwan YOO, Seoul (KR); Hyeshin LEE, Seoul (KR)

(73) Assignee: LG ELECTRONICS INC., Seoul (KR)

(21) Appl. No.: 18/014,258

(22) PCT Filed: Jun. 30, 2021
(86) PCT No.: PCT/KR2021/008217

§ 371 Date: Jan. 3, 2023

(30) Foreign Application Priority Data
Jul. 1, 2020 (KR) 10-2020-0080834

(51) Int. Cl. A47L 11/40; A47L 11/282

(52) U.S. Cl. CPC A47L 11/4011; A47L 11/282; A47L 11/4008; A47L 11/4038; A47L 11/4083; A47L 11/4091; A47L 2201/022; A47L 2201/04

(57) ABSTRACT

The present invention relates to a robot cleaner that cleans a surface to be cleaned using one or more mops while autonomously driving, and includes a body and a display unit provided on the body and to display information on the robot cleaner to be provided to a user, the display unit including a display means coupled to an upper surface of the body and to display a status of the robot cleaner on a screen, and a voice transmitting means coupled to the body and to output a sound from the robot cleaner, the display unit controlled based on a control signal transmitted from the user through an external control device.

### TECHNICAL FIELD

The present invention relates to a robot cleaner in which a user can control a display unit through an external control device.

### BACKGROUND ART

A robot cleaner is a household robot that autonomously drives on a surface to be cleaned with a certain area and removes dust or foreign substances around it, and according to its function, it is generally classified into a suction-type robot cleaner that sucks dust by vacuum, and a wet robot cleaner with a web mop function that wipes the floor surface of an area to be cleaned using a mop.

On the other hand, the wet robot cleaner (hereinafter referred to as “robot cleaner”) having the wet mop function has a water container, and it is configured to supply the water contained in the water container to the mop, and to wipe the floor surface with the moisture mop, thereby effectively removing foreign substance strongly attached to the floor surface.

As a conventional reference related to a robot cleaner, Korean Patent Registration No. 10-1352518 discloses a remote control system of a mobile robot configured to include a mobile robot that receives a control signal, performs a charging command included in the control signal, and transmits a response signal to the control signal, and a terminal device that generates the control signal corresponding to the charging command and transmits it to the mobile robot, and generates and displays a control screen based on the response signal.

However, the screen of the terminal device disclosed in Korean Patent Registration No. 10-1352518, is configured to remotely control only limited functions of patrol, cleaning, and charging operations, and there is a problem that the user cannot directly input detailed settings of the mobile robot.

### DOCUMENT OF RELATED ART

### Patent Document

(Patent Literature 1) Korean Patent Registration No. 10-1352518

### DISCLOSURE

### Technical Problem

An object of the present invention is to provide a robot cleaner capable of changing volume level of a voice transmitting means included in a display unit.

An object of the present invention is to provide a robot cleaner capable of changing screen brightness of a display means included in a display unit.

An object of the present invention is to provide a robot cleaner that can periodically notify a user about mop washing.

An object of the present invention is to provide a robot cleaner capable of informing a user of a current location of a robot cleaner.

### Technical Solution

In order to achieve the above object, the present invention provides a robot cleaner which cleans a surface to be cleaned using one or more mops while automatically driving, including a body; and a display unit that is provided on the body and displays information on the robot cleaner to be provided to a user, wherein the display unit includes a display means that is coupled to an upper surface of the body and displays a status of the robot cleaner on a screen, and a voice transmitting means that is coupled to the body and outputs a sound from the robot cleaner, the display unit is controlled based on a control signal transmitted from the user through an external control device.

Here, the control signal transmitted from the user through the external control device is a control signal corresponding to a set value of volume of the voice transmitting means, the voice transmitting means may be controlled such that a volume level of sound transmitted becomes the set value of volume.

In addition, the control signal transmitted from the user through the external control device is a control signal corresponding to a set value of brightness of the display means, the display means may be controlled such that brightness of the screen becomes the set value of brightness.

In addition, the control signal transmitted from the user through the external control device is a control signal corresponding to a command to return the robot cleaner to a charging station, when the robot cleaner enters the charging station, the voice transmitting means may be controlled to transmit a washing notification of the mop.

In this case, the voice transmitting means may be controlled to retransmit the washing notification every time a preset predetermined time elapses after the washing notification is first transmitted.

In addition, the control signal transmitted from the user through the external control device is a control signal corresponding to a command to search for a current location of the robot cleaner, the voice transmitting means may be controlled to transmit a warning sound when the control signal is received.

Meanwhile, the robot cleaning system according to an embodiment of the present invention may include a robot cleaner that cleans a surface to be cleaned using one or more mops while automatically driving and includes a body and a display unit that is provided on the body and displays information on the robot cleaner to be provided to a user; and an external control device that includes a display unit to display a control screen, and generates a control signal for controlling the display unit based on a user input inputted through the control screen to transmit the control signal to the robot cleaner.

Here, the external control device displays a plurality of selectable preset set values of volume on the control screen, and when the user input selecting one of the plurality of set values of volume is received, the external control device may transmit to the robot cleaner a control signal for controlling volume level of sound transmitted from the display unit to the selected set value of volume.

In addition, the external control device displays a plurality of selectable preset set values of brightness on the control screen, when the user input selecting one of the plurality of set values of brightness is received, the external control device may transmit to the robot cleaner a control signal for controlling screen brightness of the display unit to the selected set value of brightness.

In addition, the external control device displays a cleaner search item for searching a current location of the robot cleaner on the control screen, when the user input selecting the cleaner search item is received, the external control device may receive a location where the robot cleaner stops driving from the robot cleaner, and display the location where the robot cleaner stops driving as an image on the control screen as the current location of the robot cleaner.

Meanwhile, the robot cleaning system according to another embodiment of the present invention further includes other cleaner to perform a cleaning operation in cooperation with the robot cleaner, when the external control device receives the user input selecting the other cleaner on the control screen, the robot cleaner receives a cleaning completion signal transmitted after the other cleaner completes cleaning and starts the cleaning operation.

### Advantageous Effect

The robot cleaner according to the present invention may change the volume level of a voice transmitting means to a level desired by a user by controlling the volume level of the voice transmitting means with a set value of volume set by the user through an external control device.

In addition, the robot cleaner according to the present invention can change the screen brightness of a display means to a brightness desired by a user by controlling the screen brightness of the display means with a set value of brightness set by the user through an external control device.

In addition, the robot cleaner according to the present invention is configured to transmit a reminder of mop washing from a voice transmitting means and to repeat it at a predetermined time interval, so that a user may be advised periodically about the mop washing.

In addition, the robot cleaner according to the present invention is configured to transmit a warning sound from a voice transmitting means when a user sends a control signal for searching for the current location of the robot cleaner through an external control device, so that the user can be informed of the current location of the robot cleaner.

### DESCRIPTION OF DRAWINGS

FIG. 1 is a conceptual view of a robot cleaning system according to an embodiment of the present invention.

FIG. 2a is a perspective view illustrating a robot cleaner according to an embodiment of the present invention.

FIG. 2b is a view illustrating a partially separated configuration of a robot cleaner according to an embodiment of the present invention.

FIG. 2c is a rear view of a robot cleaner according to an embodiment of the present invention.

FIG. 2d is a bottom view of a robot cleaner according to an embodiment of the present invention.

FIG. 2e is an exploded perspective view of a robot cleaner according to an embodiment of the present invention.

FIG. 2f is an internal cross-sectional view of a robot cleaner according to an embodiment of the present invention.

FIG. 3 is a block diagram of a robot cleaner according to an embodiment of the present invention.

FIG. 4 is an internal block diagram of an external control device of FIG. 1.

FIG. 5 is a view illustrating a control screen of an external control device for inputting a set value of volume.

FIG. 6 is a view illustrating a control screen of an external control device for inputting a set value of brightness.

FIG. 7 is a view illustrating a control screen of an external control device that has received information on a washing notification from a robot cleaner.

FIG. 8 is a view illustrating a control screen of an external control device for searching a current location of a robot cleaner.

FIG. 9 is a flowchart illustrating a method of setting a volume level of a voice transmitting means in a robot cleaner.

FIG. 10 is a flowchart illustrating a method of setting screen brightness of a display means in a robot cleaner.

FIG. 11 is a flowchart illustrating a method in which a robot cleaner transmits a mop washing notification.

FIG. 12 is a flowchart illustrating a method in which a robot cleaner guides a user to a current location of the robot cleaner.

FIG. 13 is a conceptual view of a robot cleaning system according to another embodiment of the present invention.

FIG. 14 is a flowchart illustrating a method of performing a cooperative cleaning operation in conjunction with another cleaner in a control method of a robot cleaning system according to another embodiment of the present invention.

FIGS. 15a and 15b are views illustrating a control screen of an external control device for setting the cooperative cleaning operation in a robot cleaning system according to another embodiment of the present invention.

### MODE FOR INVENTION

Hereinafter, preferred embodiments of the present invention will be described in detail with reference to the accompanying drawings.

Since the present invention can have various changes and can have various embodiments, specific embodiments are illustrated in the drawings and will be described in detail in the detailed description. This is not intended to limit the present invention to a specific embodiment, it should be construed to include all modifications, equivalents and substitutes included in the spirit and scope of the present invention.

In describing the present invention, terms such as first and second may be used to describe various components, but the components may not be limited by the terms. The above terms are only for the purpose of distinguishing one component from another. For example, without departing from the scope of the present invention, a first component may be referred to as a second component, and similarly, a second component may also be referred to as a first component.

The term “and/or” may include a combination of a plurality of related listed items or any of a plurality of related listed items.

When a component is referred to as being “connected” or “contacted” to another component, it may be directly connected or contacted to the other component, but it may be understood that other components may exist in between. On the other hand, when it is mentioned that a certain element is “directly connected” or “directly contacted” to another element, it may be understood that the other element does not exist in the middle.

The terms used in the present application are only used to describe specific embodiments, and are not intended to limit the present invention. The singular expression may include the plural expression unless the context clearly dictates otherwise.

In the present application, terms such as “comprise” or “have” are intended to designate that a feature, number, step, operation, component, part, or combination thereof described in the specification exists, and it may be understood that the presence or addition of one or more other features, numbers, steps, operations, components, parts, or combinations thereof is not precluded in advance.

Unless defined otherwise, all terms used herein, including technical or scientific terms, may have the same meaning as commonly understood by one of ordinary skill in the art to which this invention belongs. Terms such as those defined in a commonly used dictionary may be interpreted as having a meaning consistent with the meaning in the context of the related art, and unless explicitly defined in the present application, it may not be interpreted in an ideal or excessively formal meaning.

In addition, the following embodiments are provided to more completely explain to those with average knowledge in the art, and the shapes and sizes of elements in the drawings may be exaggerated for clearer explanation.

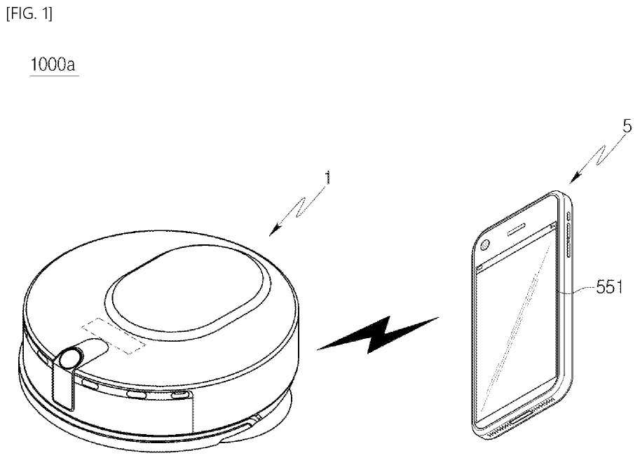

FIG. 1 is a conceptual view of a robot cleaning system according to an embodiment of the present invention.

Referring to FIG. 1, a robot cleaning system 1000a according to an embodiment of the present invention includes a robot cleaner 1 and an external control device 5 for remotely controlling the robot cleaner.

Here, the robot cleaner 1 autonomously drives and cleans a surface to be cleaned of an internal space in which the robot cleaner 1 itself is installed. The robot cleaner 1 is installed in an inner space of a house and is configured to perform a cleaning operation of autonomously cleaning a floor surface, which is the surface to be cleaned, according to a preset pattern or a command designated/inputted by a user while driving using one or more mops, and to perform short-range wireless communication.

The robot cleaner 1 may be remotely controlled by the external control device 5.

In this case, the external control device 5 is a portable wireless communication electronic device. For example, the external control device 5 may be a mobile phone, a PDA, a laptop, a digital camera, a game machine, an e-book, and the like. In addition, the external control device 5 may support short-range communication corresponding to the short-range communication of the robot cleaner 1.

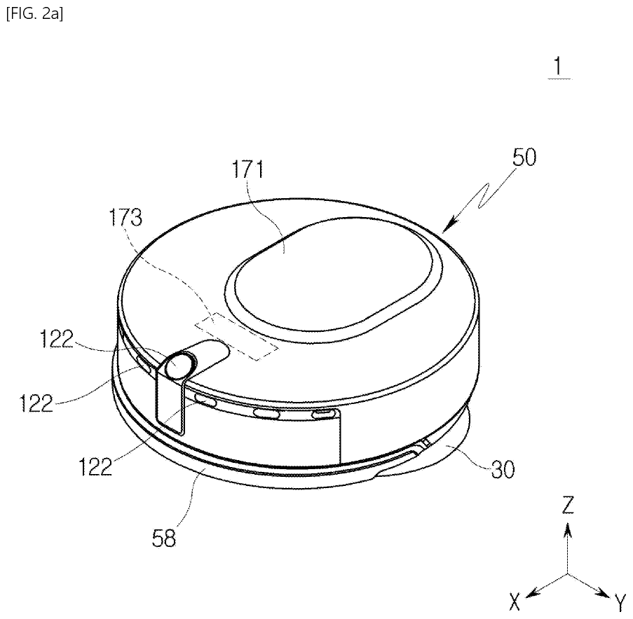

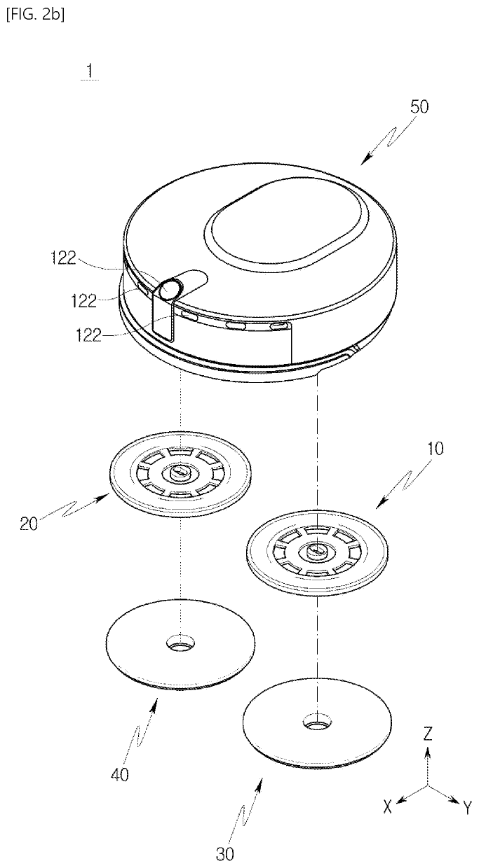

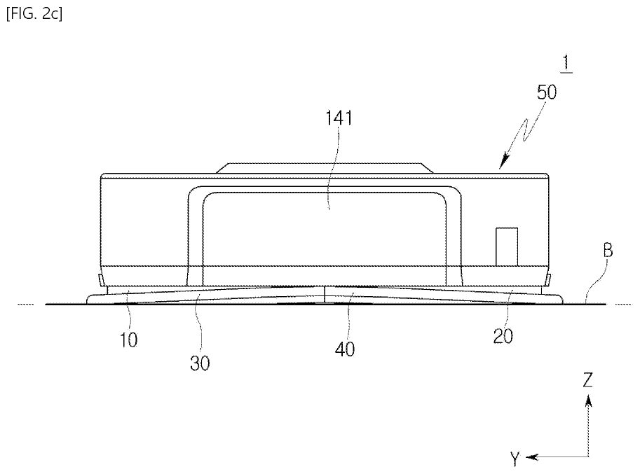

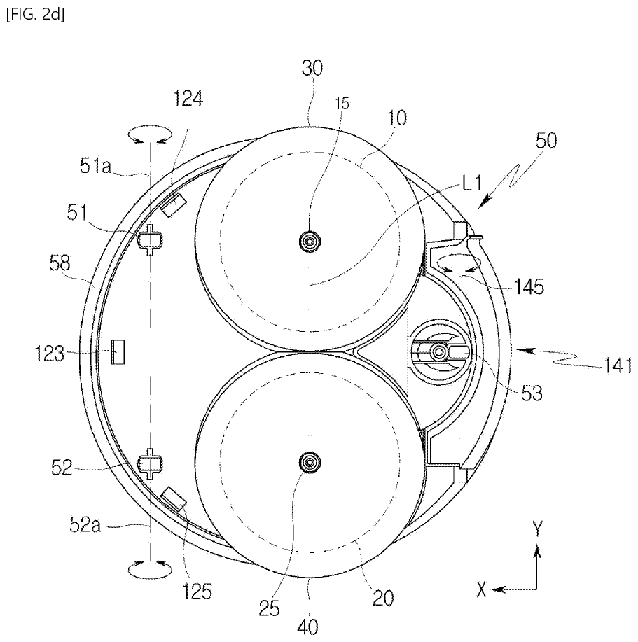

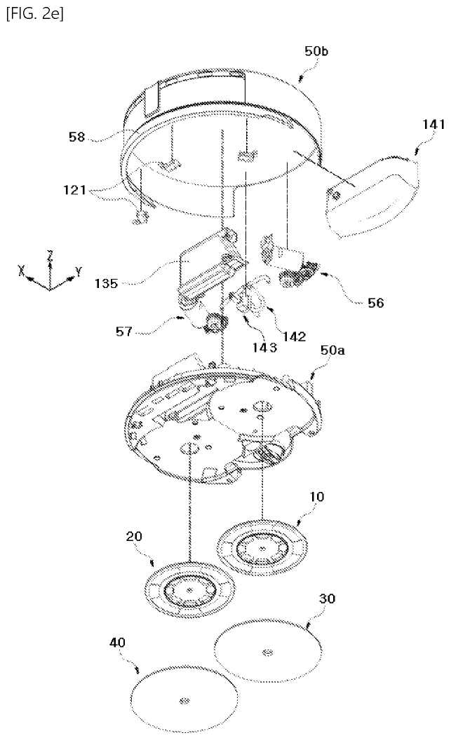

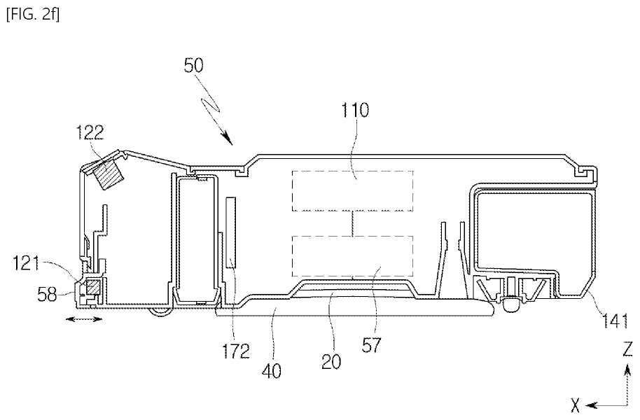

FIGS. 2a to 2f are structural views for explaining the structure of the robot cleaner 1 of FIG. 1.

More specifically, FIG. 2a is a perspective view showing a robot cleaner, FIG. 2b is a view illustrating a partially separated configuration of the robot cleaner, FIG. 2c is a rear view of the robot cleaner, FIG. 2d is a bottom view of the robot cleaner, FIG. 2e is an exploded perspective view of the robot cleaner, and FIG. 2f is an internal cross-sectional view of the robot cleaner.

The robot cleaner 1 is placed on a floor and moved along a floor surface B to clean the floor using a mop. Accordingly, in the following description, a vertical direction is determined based on the state in which the robot cleaner 1 is placed on the floor.

And, based on a first rotation plate 10 and a second rotation plate 20, a side to which a first lower sensor 123, which will be described later, is coupled is set as a front side.

The ‘lowest part’ of each configuration described in the present invention may be the lowest-positioned part in each configuration when the robot cleaner 1 is placed on the floor for using, or may be a part closest to the floor.

The robot cleaner 1 may include a body 50, a first rotation plate 10, a second rotation plate 20, mops 30, 40.

The body 50 may form the overall outer shape of the robot cleaner 1 or may be formed in the form of a frame. Each component constituting the robot cleaner 1 may be coupled to the body 50, and some components constituting the robot cleaner 1 may be accommodated in the body 50. The body 50 can be divided into a lower body 50a and an upper body 50b, and the components of the robot cleaner 1 can be provided in a space in which the lower body 50a and the upper body 50b are coupled to each other. (Refer to FIG. 2e).

The first rotation plate 10 is made to have a predetermined area, and is formed in the form of a flat plate, a flat frame and the like. The first rotation plate 10 is generally laid horizontally, and thus, the width (or diameter) in the horizontal direction is sufficiently larger than the vertical height. The first rotation plate 10 coupled to the body 50 may be parallel to the floor surface B, or may form an inclination with the floor surface B. The first rotation plate 10 may be formed in a circular plate shape, the bottom surface of the first rotation plate 10 may be generally circular, and the first rotation plate 10 may be formed in a rotationally symmetrical shape as a whole.

The second rotation plate 20 is made to have a predetermined area, and is formed in the form of a flat plate, a flat frame and the like. The second rotation plate 20 is generally laid horizontally, and thus, the horizontal width (or diameter) is sufficiently larger than the vertical height. The second rotation plate 20 coupled to the body 50 may be parallel to the floor surface B, or may be inclined with the floor surface B. The second rotation plate 20 may be formed in a circular plate shape, the bottom surface of the second rotation plate 20 may be substantially circular, and the second rotation plate 20 may have a rotationally symmetrical shape as a whole.

In the robot cleaner 1, the second rotation plate 20 may be the same as the first rotation plate 10, or may be symmetrically formed. If the first rotation plate 10 is located on the left side of the robot cleaner 1, the second rotation plate 20 may be located on the right side of the robot cleaner 1, and in this case, the first rotation plate 10 and the second rotation plate 20 can be symmetrical to each other.

The robot cleaner 1 may include one or more mops 30 and 40. For example, the robot cleaner may be configured to include a first mop 30 and a second mop 40.

The first mop 30 has a bottom surface facing the floor to have a predetermined area, and the first mop 30 has a flat shape. The first mop 30 is formed in a form in which the width (or diameter) in the horizontal direction is sufficiently larger than the height in the vertical direction. When the first mop 30 is coupled to the body 50, the bottom surface of the first mop 30 may be parallel to the floor surface B, or may be inclined with the floor surface B.

The bottom surface of the first mop 30 may form a substantially circular shape, and the first mop 30 may be formed in a rotationally symmetrical shape as a whole. In addition, the first mop 30 may be detachably attached to the bottom surface of the first rotation plate 10, and may be coupled to the first rotation plate 10 to rotate together with the first rotation plate 10.

The second mop 40 has a bottom surface facing the floor to have a predetermined area, and the second mop 40 has a flat shape. The second mop 40 is formed in a form in which the width (or diameter) in the horizontal direction is sufficiently larger than the height in the vertical direction. When the second mop 40 is coupled to the body 50, the bottom surface of the second mop 40 may be parallel to the floor surface B, or may be inclined with the floor surface B.

The bottom surface of the second mop 40 may form a substantially circular shape, and the second mop 40 may have a rotationally symmetrical shape as a whole. In addition, the second mop 40 may be detachably attached to the bottom surface of the second rotation plate 20, and coupled to the second rotation plate 20 to rotate together with the second rotation plate 20.

When the first rotation plate 10 and the second rotation plate 20 rotate in opposite directions at the same speed, the robot cleaner 1 may move in a linear direction, and move forward or backward. For example, when viewed from above, when the first rotation plate rotates counterclockwise and the second rotation plate 20 rotates clockwise, the robot cleaner 1 may move forward.

When only one of the first rotation plate 10 and the second rotation plate 20 rotates, the robot cleaner 1 may change direction and turn around.

When the rotation speed of the first rotation plate 10 and the rotation speed of the second rotation plate 20 are different from each other, or when the first rotation plate 10 and the second rotation plate 20 rotate in the same direction, the robot cleaner 1 can move while changing direction, and move in a curved direction.

The robot cleaner 1 may further include a first lower sensor 123.

The first lower sensor 123 is formed on the lower side of the body 50, and is configured to detect a relative distance to the floor surface B. The first lower sensor 123 may be formed in various ways within a range capable of detecting the relative distance between the point where the first lower sensor 123 is formed and the floor surface B.

When the relative distance (which may be a distance in a vertical direction from the floor surface, or a distance in an inclined direction from the floor surface) to the floor surface B, detected by the first lower sensor 123 exceeds a predetermined value or a predetermined range, it may be the case in which the floor surface may be suddenly lowered, and accordingly, the first lower sensor 123 may detect a cliff.

The first lower sensor 123 may be formed of a photosensor, and may be configured to include a light emitting unit for irradiating light and a light receiving unit through which the reflected light is incident. The first lower sensor 123 may be an infrared sensor.

The first lower sensor 123 may be referred to as a cliff sensor.

The robot cleaner 1 may further include a second lower sensor 124 and a third lower sensor 125.

When a virtual line connecting the center of the first rotation plate 10 and the center of the second rotation plate 20 in a horizontal direction (a direction parallel to the floor surface B) is referred to as a connection line L1, the second lower sensor 124 and the third lower sensor 125 may be formed on the lower side of the body 50 on the same side as the first lower sensor 123 with respect to the connection line L1, and configured to sense the relative distance to the floor surface B (Refer to FIG. 2d).

The third lower sensor 125 may be formed opposite to the second lower sensor 124 based on the first lower sensor 123.

Each of the second lower sensor 124 and the third lower sensor 125 may be formed in various ways within a range capable of detecting a relative distance to the floor surface B. Each of the second lower sensor 124 and the third lower sensor 125 may be formed in the same manner as the above-described first lower sensor 123, except for a location where they are formed.

The robot cleaner 1 may further include a first actuator 56, a second actuator 57, a battery 135, a water container 141, and a water supply tube 142.

The first actuator 56 is configured to be coupled to the body 50 to rotate the first rotation plate 10.

The first actuator 56 may be configured to include a first motor and one or more first gears.

The first motor may be an electric motor.

The plurality of first gears is configured to rotate while interlocking with each other, connects the first motor and the first rotation plate 10, and transmits the rotational power of the first motor to the first rotation plate 10. Accordingly, the first rotation plate rotates when the rotating shaft of the first motor rotates.

The second actuator 57 is configured to be coupled to the body 50 to rotate the second rotation plate 20.

The second actuator 57 may be configured to include a second motor and one or more second gears.

The second motor may be an electric motor.

The plurality of second gears is configured to rotate while interlocking with each other, connects the second motor and the second rotation plate 20, and transmits the rotational power of the second motor to the second rotation plate 20. Accordingly, when the rotation shaft of the second motor rotates, the second rotation plate 20 rotates.

As such, in the robot cleaner 1, the first rotation plate 10 and the first mop 30 may be rotated by the operation of the first actuator 56, and the second rotation plate 20 and the second mop 40 may be rotated by the operation of the second actuator 57.

The second actuator 57 may form a symmetry (left and right symmetry) with the first actuator 56.

The battery 135 is configured to be coupled to the body 50 to supply power to other components constituting the robot cleaner 1. The battery 135 may supply power to the first actuator 56 and the second actuator 57, and in particular, supply power to the first motor and the second motor.

The battery 135 may be charged by an external power source, and for this purpose, a charging terminal for charging the battery 135 may be provided on one side of the body 50 or the battery 135 itself.

In the robot cleaner 1, the battery 135 may be coupled to the body 50.

The water container 141 is made in the form of a container having an internal space so that a liquid such as water is stored therein. The water container 141 may be fixedly coupled to the body 50, or detachably coupled to the body 50.

In the robot cleaner 1, the water supply tube 142 is formed in the form of a tube or pipe, and is connected to the water container 141 so that the liquid inside the water container 141 flows through the inside thereof. The water supply tube 142 is configured such that the opposite end connected to the water container 141 is located on the upper side of the first rotation plate 10 and the second rotation plate 20, and accordingly, the liquid inside the water container 141 can be supplied to the mop 30 and the second mop 40.

In the robot cleaner 1, the water supply tube 142 may be formed in a form in which one tube is branched into two, in this case, one branched end is located on the upper side of the first rotation plate 10, and the other branded end is located on the upper side of the second rotation plate 20.

The robot cleaner 1 may include a water pump 143 to move the liquid through the water supply tube 142.

The water pump 143 is connected to the water container 141 and is configured to move the liquid (water) through the water supply tube 142 to supply to the first mop 30 and the second mop 40.

The robot cleaner 1 may further include a bumper 58, a first sensor 121, and a second sensor 122.

The bumper 58 is coupled along the outline of the body 50, and is configured to move relative to the body 50. For example, the bumper 58 may be coupled to the body 50 so as to reciprocate along a direction approaching the center of the body 50.

The bumper 58 may be coupled along a portion of the outline of the body 50, or may be coupled along the entire outline of the body 50.

The first sensor 121 may be coupled to the body 50 and configured to detect a movement (relative movement) of the bumper 58 with respect to the body 50. The first sensor 121 may be a collision detection sensor, and may be formed using a microswitch, a photo interrupter, a tact switch and the like.

The second sensor 122 may be coupled to the body 50 and configured to detect a relative distance to an obstacle. The second sensor 122 may be a distance sensor.

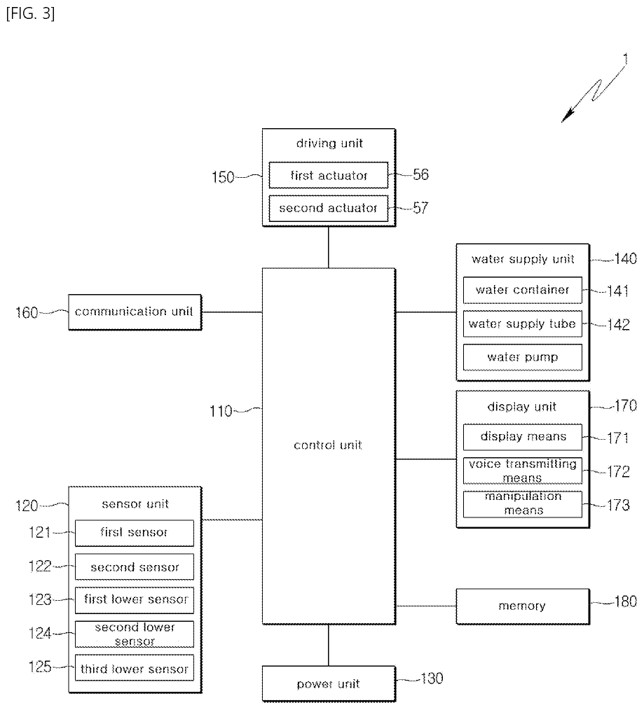

FIG. 3 is a block diagram of the robot cleaner shown in FIG. 1 of the present invention.

Referring to FIG. 3, the robot cleaner 1 may include a control unit 110, a sensor unit 120, a power unit 130, a water supply unit 140, a driving unit 150, a communication unit 160, a display unit 170 and a memory 180. The components shown in the block diagram of FIG. 3 are not essential for implementing the robot cleaner 1, so the robot cleaner 1 described in the present specification can have more or fewer components than those listed above.

First, the control unit 110 may be connected to the control device 5 through wireless communication by a communication unit 160 to be described later. In this case, the control unit 110 may transmit various data about the robot cleaner 1 to the connected control device 5. And, it is possible to receive data from the connected control device 5 and store it. Here, the data input from the control device 5 may be a control signal for controlling at least one function of the robot cleaner 1.

In other words, the robot cleaner 1 may receive a control signal based on a user input from the control device 5 and operate according to the received control signal.

In addition, the control unit 110 may control the overall operation of the robot cleaner. The control unit 110 controls the robot cleaner 1 to autonomously drive a surface to be cleaned and perform a cleaning operation according to the set information stored in the memory 180 to be described later.

The sensor unit 120 may include one or more of the first lower sensor 123, the second lower sensor 124, the third lower sensor 125, the first sensor 121 and the second sensor 122 of the robot cleaner 1 described above.

In other words, the sensor unit 120 may include a plurality of different sensors capable of detecting the environment around the robot cleaner 1, and the information on the environment around the robot cleaner 1 detected by the sensor unit 120 may be transmitted to the control device 5 by the control unit 110. Here, the information on the environment may be, for example, whether an obstacle exists, whether a cliff is detected, whether a collision is detected, and the like.

The control unit 110 may be configured to control the operation of the first actuator 56 and/or the second actuator 57 according to the information of the first sensor 121. For example, when the bumper 58 comes into contact with an obstacle while the robot cleaner 1 is driving, the location where the bumper 58 comes into contact may be detected by the first sensor 121, and the control unit 110 may control the operation of the first actuator 56 and/or the second actuator 57 to leave this contact location.

In addition, according to the information of the second sensor 122, when the distance between the robot cleaner 1 and the obstacle is less than or equal to a predetermined value, the control unit 110 may control the operation of the first actuator 56 and/or the second actuator 57 such that the driving direction of the robot cleaner 1 is switched, or the robot cleaner 1 moves away from the obstacle.

In addition, according to the distance detected by the first lower sensor 123, the second lower sensor 124 or the third lower sensor 125, the control unit 110 may control the operation of the first actuator 56 and/or the second actuator 57 such that the robot cleaner 1 stops or changes the driving direction.

Meanwhile, the power unit 130 receives external power and internal power under the control of the control unit 110 to supply power required for operation of each component. The power unit 130 may include the battery 135 of the robot cleaner 1 described above.

The water supply unit 140 may include the water container 141, the water supply tube 142, and the water pump 143 of the robot cleaner 1 described above. The water supply unit 140 can be formed to adjust the water supply amount of the liquid (water) supplied to the first mop 30 and the second mop 40 during the cleaning operation of the robot cleaner 1 according to the control signal of the control unit 110. The control unit 110 may control a driving time of a motor that drives the water pump 143 to adjust the water supply amount.

Alternatively, the water supply unit 140 may be controlled to remove the residual water in the water container 141 when a pressing operation is applied to the bumper 58 in a residual water removal mode to be described later. In this regard, the control unit 110 may detect the pressing operation applied to the bumper 58 through the first sensor 121 that detects the relative movement of the bumper 58.

The driving unit 150 may include the first actuator 56 and the second actuator 57 of the robot cleaner 1 described above. The driving unit 150 may be formed such that the robot cleaner 1 rotates or moves in a straight line according to a control signal of the control unit 110.

Meanwhile, the communication unit 160 may include at least one module that enables wireless communication between the robot cleaner 1 and a wireless communication system, or between the robot cleaner 1 and a preset peripheral device, or between the robot cleaner 1 and a preset external server.

In this case, the preset peripheral device may be the control device 5 according to an embodiment of the present invention.

For example, the at least one module may include at least one of an IR (Infrared) module for infrared communication, an ultrasonic module for ultrasonic communication, or a short-range communication module such as a WiFi module or a Bluetooth module. Alternatively, it may be formed to transmit/receive data to/from a preset device through various wireless technologies such as wireless LAN (WLAN) and wireless-fidelity (Wi-Fi), including wireless internet module.

Meanwhile, the display unit 170 displays information to be provided to a user. For example, the display unit 170 may include a display means 171 that displays the status of the robot cleaner 1 on a screen.

In addition, the display means 171 of the display unit 170 may be formed of any one of a light emitting diode (LED), a liquid crystal display (LCD), a plasma display panel, and an organic light emitting diode (OLED).

In this case, the display means 171 may display information such as operation time information of the robot cleaner 1, battery power information, and the lime. The display means 171 is coupled to the body 50, more particularly, it may be provided on the upper surface of the upper body 50b of the robot cleaner 1 so that the user can easily recognize the information displayed on the display means 171. (Refer to FIG. 2a).

In addition, the display unit 170 may include a voice transmitting means 172 for outputting a sound. The voice transmitting means 172 may be, for example, a speaker, and the source of the sound output by the speaker may be sound data prestored in the robot cleaner 1. For example, the prestored sound data may be about a voice guidance corresponding to each function of the robot cleaner 1 or a warning sound for notifying an error.

In this case, the voice transmitting means 172 may be coupled to the body 50, more particularly, it may be accommodated in the inner space formed by the upper body 50b and the lower body 50a of the robot cleaner 1. More specifically, the voice transmitting means 172 may be provided on the rear side of the battery 135 (Refer to FIG. 20.

In addition, the display unit 170 may include a manipulation means 173. The manipulation means 173 may be configured as a conventional button, a touch panel, and the like, so that a user may input a command regarding the operation of the robot cleaner 1 by touching it or pressing it with a predetermined force.

For example, the manipulation means 173 may be provided on the upper surface of the upper body 50b of the robot cleaner 1 and configured to turn on or turn off the power of the robot cleaner 1 when the user presses it. (Refer to FIG. 2a)

In addition, the manipulation means 173 may further include a start button for starting or pausing the cleaning operation of the robot cleaner 1 and/or a charging button for returning the robot cleaner 1 to a charging station.

Meanwhile, the display unit 170 may be controlled based on a control signal transmitted by a user.

More specifically, the displaying means 171 or the voice transmitting means 172 of the display unit 170 may be controlled according to the type of the control signal transmitted by the user.

For example, when the control signal transmitted from the user is a control signal corresponding to the set value of volume of the voice transmitting means 172, the control unit 110 may control the volume level of the voice transmitting means 172 to the set value of volume.

In this case, the control signal corresponding to the set value of volume may be remotely transmitted by the user input inputted by the user through the external control device 5.

Also, as an example, when the control signal transmitted from the user is a control signal corresponding to the set value of brightness of the display means 171, the control unit 110 may control the screen brightness of the display means 171 to the set value of brightness.

In this case, the control signal corresponding to the set value of brightness may be remotely transmitted by the user input inputted by the user through the external control device 5.

In addition, as an example, when the control signal transmitted from the user is a control signal corresponding to a command to return a charging station, the control unit 110 may detect that the robot cleaner 1 enters the charging station, and control the voice transmitting means 172 to transmit a washing notification of the mops 30, 40.

In this case, the control signal corresponding to the command to return to a charging station may be remotely transmitted by the user input inputted by the user through the external control device 5.

Alternatively, the control signal corresponding to the command to return to a charging station may be transmitted through an operation in which the user presses the charging button included in the manipulation means 173 of the robot cleaner 1.

On the other hand, when the robot cleaner 1 automatically returns to the charging station after completing the cleaning operation, the control unit 110 may control the voice transmitting means 172 to transmit the washing notification of the mops 30, 40, at the same time as the body 50 enters the charging station and charging starts even without the user input.

Meanwhile, the control unit 110 may control the voice transmitting means 172 to retransmit the washing notification of the mop 30, 40 each time a present predetermined time (N hour) elapses after the washing notification is first transmitted from the voice transmitting means 172.

For example, if the preset predetermined time is 1 hour, the washing notification may be transmitted, at the same time as the robot cleaner 1 enters the charging station, and the washing notification may be retransmitted every time after 1 hour elapses. In this case, the transmitted washing notification may be a voice message to guide the content to wash the mops 30, 40. Through this, the user's attention can be called to prevent the robot cleaner 1 from being left in a state with a contaminated mop attached after completing the cleaning operation.

Meanwhile, the control unit 110 may transmit the information on the washing notification to the external control device 5, at the same time as controlling the voice transmitting means 172 to retransmit the washing notification when the preset predetermined time elapses after the washing notification is first transmitted from the voice transmitting means 172.

In this case, as will be described later, based on the information on the washing notification transmitted to the external control device 5, a message guiding the mop washing notification may be displayed as a popup message on the control screen of the external control device 5 as a popup message.

In addition, when receiving a release control signal for canceling the transmission of the washing notification from the user, the control unit 110 may control the voice transmitting means 172 not to transmit the washing notification any longer.

In this case, the release control signal may be generated by, for example, a user pressing the power button included in the manipulation means 173 of the robot cleaner 1. Through this, the user can easily cancel the transmission of the washing notification, and it is possible to prevent the notification from continuously sending out and causing unnecessary noise.

In addition, as an example, when the control signal transmitted from the user through the external control device 5 is a control signal corresponding to a command to search for the current location of the robot cleaner 1, the control unit 110 may control the voice transmitting means 172 to transmit a warning sound, at the same time as receiving the control signal.

In this case, the control signal corresponding to the command to search for the current location may be remotely transmitted by the user input inputted by the user through the external control device 5.

Through this, the user can easily find the current position of the robot cleaner 1.

In addition, the control unit 110 may transmit information on the current location of the robot cleaner 1 to the external control device 5, at the same time as controlling the voice transmitting means 172 to transmit the warning sound.

The information on the current location may be information corresponding to a location where the robot cleaner 1 stops driving.

In this case, as will be described later, the information on the current location may be provided as an image to the user through the external control device 5. Through this, the user can easily find the current location of the robot cleaner 1 through the external control device 5 even when the volume level of the warning sound transmitted from the robot cleaner 1 is small or when it is difficult to determine the location of the robot cleaner 1 even after listening the warning sound.

Lastly, the memory 180 may include various data for driving and operating the robot cleaner 1. The memory 180 may include an application program for autonomous driving of the robot cleaner 1 and various related data. In addition, each data sensed by the sensor unit 120 may be stored, and the information on various settings (values) selected or input by the user may be included.

For example, the memory 180 may include information on setting the screen brightness of the display means 171 according to a set value of brightness input from the user through the external control device 5.

Alternatively, as an example, the memory 180 may include information on setting the volume level of the voice transmitting means 172 according to the set value of volume input from the user through the external control device 5.

Alternatively, as an example, the memory 180 may include information on setting for the transmission period of the mop washing notification.

Meanwhile, the memory 180 may include information on the surface to be cleaned currently given to the robot cleaner 1. For example, the information on the surface to be cleaned may be map information mapped by the robot cleaner 1 by itself. And the map information, that is, the map may include various information set by the user for each area constituting the surface to be cleaned.

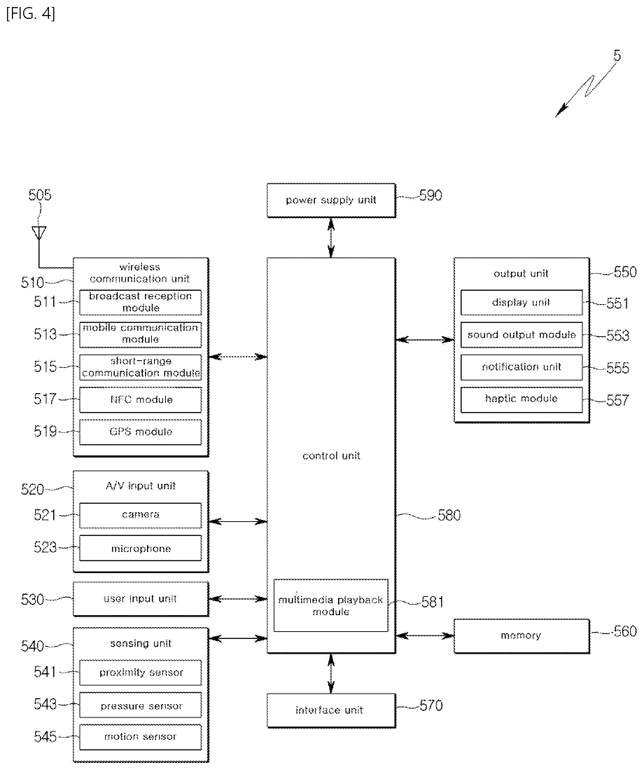

FIG. 4 is an internal block diagram of the external control device of FIG. 1.

Referring to FIG. 4, the external control device 5 may include a server, a wireless communication unit 510 for exchanging data with other electronic devices such as the robot cleaner 1, and a control unit 580 that controls the screen of the application to be displayed on the display unit 551 according to a user input executing the application for controlling the robot cleaner 1.

In addition, the external control device 5 may further include an A/V (Audio/Video) input unit 520, a user input unit 530, a sensing unit 540, an output unit 550, a memory 560, an interface unit 570 and a power supply unit 590.

Meanwhile, the wireless communication unit 510 may receive location information and status information directly from the robot cleaner 1, or may receive location information and status information of the robot cleaner 1 through a server.

Meanwhile, the wireless communication unit 510 may include a broadcast reception module 511, a mobile communication module 513, a wireless internet module 515, a short-range communication module 517, a GPS module 519 and the like.

The broadcast reception module 511 may receive at least one of a broadcast signal and broadcast related information from an external broadcast management server through a broadcast channel. In this case, the broadcast channel may include a satellite channel, a terrestrial channel, and the like.

The broadcast signal and/or broadcast related information received through the broadcast reception module 511 may be stored in the memory 560.

The mobile communication module 513 transmits/receives wireless signals to and from at least one of a base station, an external terminal, and a server on a mobile communication network. Here, the wireless signal may include various types of data according to transmission/reception of a voice call signal, a video call signal, or text/multimedia message.

The wireless internet module 515 refers to a module for wireless internet access, and the wireless internet module 515 may be built-in or external to the external control device 5 for controlling the robot cleaner 1. For example, the wireless internet module 515 may perform WiFi-based wireless communication or WiFi Direct-based wireless communication.

The short-range communication module 517 is for short-range communication, and may support short-range communication using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (Wireless USB) technologies.

The short-distance communication module 517 may support wireless communication between the external control device 5 for controlling the robot cleaner 1 through a short-range wireless communication network (Wireless Area Networks) and a wireless communication system, between the external control device 5 and the external control device of another robot cleaner, or between the external control device 5 and another mobile terminal, or between networks in which an external server is located. The short-range wireless communication network may be Wireless Personal Area Networks.

The Global Position System (GPS) module 519 may receive location information from a plurality of GPS satellites.

Meanwhile, the wireless communication unit 510 may exchange data with a server using one or more communication modules.

The wireless communication unit 510 may include an antenna 505 for wireless communication, and may include an antenna for receiving a broadcast signal in addition to an antenna for a call and the like.

The A/V (Audio/Video) input unit 520 is for inputting an audio signal or a video signal, and may include a camera 521, a microphone 523, and the like.

The user input unit 530 generates key input data input by a user to control the operation of the external control device 5. To this end, the user input unit 530 may include a key pad, a dome switch, a touch pad (static pressure/capacitive), and the like. In particular, when the touch pad forms a mutual layer structure with the display unit 551, it may be referred to as a touch screen.

The sensing unit 540 may generate a sensing signal for controlling the operation of the external control device 5 by detecting the current status of the external control device 5 such as the opening/closing status of the external control device 5, the location of the external control device 5, the presence or absence of user contact, and the like.

The sensing unit 540 may include a proximity sensor 541, a pressure sensor 543, a motion sensor 545, and the like. The motion sensor 545 may detect a motion or location of the external control device 5 using an acceleration sensor, a gyro sensor, a gravity sensor, and the like. In particular, the gyro sensor is a sensor for measuring angular velocity, and may detect a direction (angle) that is turned with respect to a reference direction.

The output unit 550 may include a display unit 551, a sound output module 553, an alarm unit 555, a haptic module 557 and the like.

On the other hand, when the display unit 551 and the touch pad form a mutual layer structure and are configured as a touch screen, the display unit 551 may be used as an input device capable of inputting information by a user's touch in addition to an output device.

In this case, a screen for receiving an input from a user for a set value related to the control signal for controlling the robot cleaner 1 may be displayed on the display unit 551, and the information processed by the external control device 5, such as another screen that is switched from the screen according to the user input and displayed, may be displayed and output.

That is, the display unit 551 may serve to receive information by a user's touch input, and at the same time, may also serve to display the information processed by the control unit 580, which will be described later.

The sound output module 553 outputs audio data received from the wireless communication unit 510 or stored in the memory 560. The sound output module 553 may include a speaker, a buzzer, and the like.

The alarm unit 555 may output a signal for notifying the occurrence of an event in the external control device 5. For example, the signal may be output in a form of vibration.

The haptic module 557 generates various tactile effects that a user can feel. A representative example of the tactile effect generated by the haptic module 557 is a vibration effect.

The memory 560 may store a program for processing and control of the control unit 580, and perform a function for temporary storage of input or output data (for example, phonebook, message, still image, video, etc.).

The interface unit 570 functions as an interface with all external devices connected to the external control device 5. The interface unit 570 may receive data or power from such an external device and transmit it to each component inside the external control device 5, and allow the data inside the external control device 5 to be transmitted to an external device (for example, it may be transmitted to the robot cleaner 1).

The control unit 580 controls the overall operation of the external control device by generally controlling the operations of the respective units. For example, it may perform related control and processing for voice calls, data communications, video calls, and the like. In addition, the control unit 580 may include a multimedia playback module 581 for playing multimedia. The multimedia playback module 581 may be configured as a hardware in the control unit 580 or may be configured as a software separately from the control unit 580.

In addition, the control unit 580 may display a control screen for controlling the robot cleaner 1 on the display unit 551, switch the control screen to another control screen according to a user's touch input, and transmit to the robot cleaner 1 the control signal for controlling the robot cleaner 1 based on the user input inputted through the display unit 551.

Hereinafter, the control screen of the external control device 5 according to the type of user input will be described in detail for each embodiment.

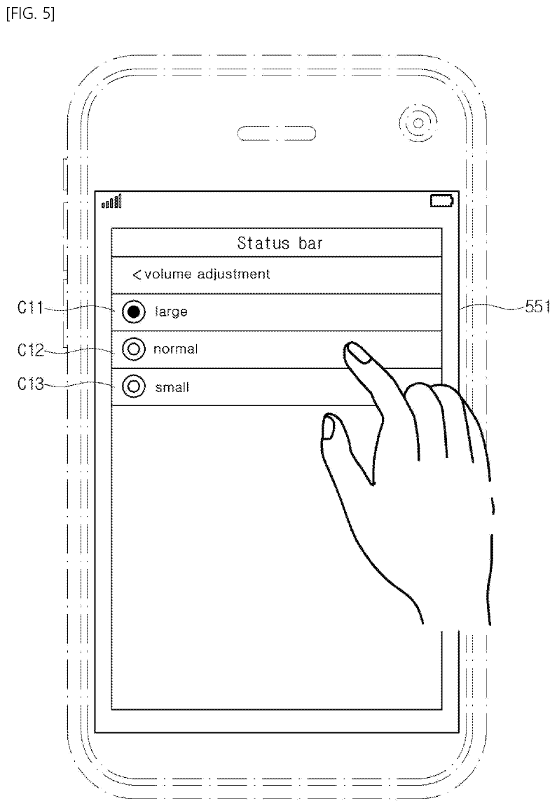

FIG. 5 is a view illustrating a control screen of an external control device for inputting a set value of volume.

Referring to FIG. 5, the control unit 580 of the external control device 5 may display a plurality of preset set values of volume C11, C12, and C13 selectable by the user on the control screen.

Here, the plurality of preset set values of volume C11, C12, C13 is displayed as three steps of “large C11, normal C12 and small C13”, as shown in FIG. 5, for example.

In addition, a default set value of the volume level may be “large C11”.

When receiving the user input selecting one of the plurality of set values of volume C11, C12, and C13, the control unit 580 may transmit a control signal corresponding to the selected set value of volume to the robot cleaner 1.

For example, as shown in FIG. 5, when the user touches the control screen and selects the set value of volume as “Normal C12”, the control unit 580 may transmit a control signal corresponding to the volume level “Normal” to the robot cleaner 1.

However, the plurality of set values of volume C11, C12, and C13 illustrated in FIG. 5 is examples, and a larger number of set values of volume may be displayed or a smaller number of set values of volume may be displayed.

Alternatively, the plurality of set values of volume C11, C12, and C13 may be displayed as values representing the volume level as a percentage (%).

In this way, the control unit 580 of the external control device 5 displays a plurality of set values of volume selectable by the user on the control screen, so that the user can adjust the volume level of the voice transmitting means 172 to a desired level according to a situation.

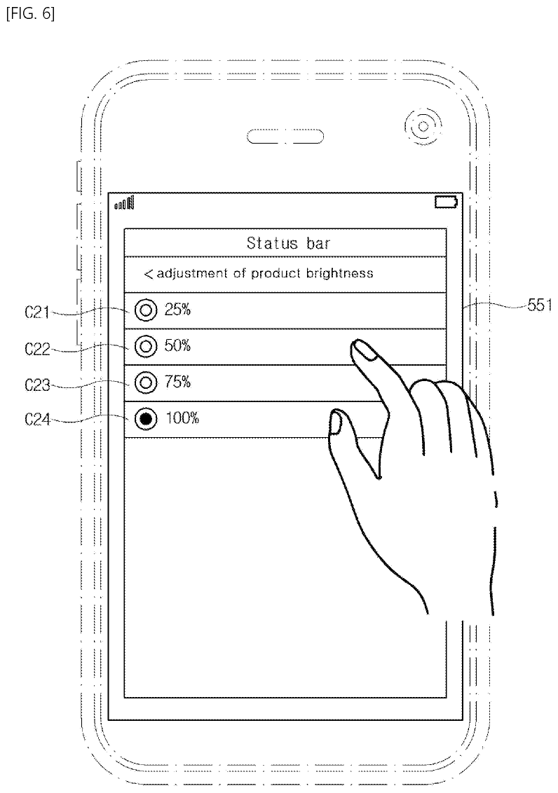

FIG. 6 is a view illustrating a control screen of an external control device for inputting a set value of brightness.

Referring to FIG. 6, the control unit 580 of the external control device 5 may display a plurality of preset set values of brightness C21, C22, C23, and C24 selectable by the user on the control screen.

Here, the plurality of preset set values of brightness C21, C22, C23, and C24 may be expressed as a value represented by the illuminance ratio of the screen of the display means 171 as “25%, 50%, 75% and 100%”, as shown in FIG. 6.

In addition, a default set value of brightness may be 100%.

When the control unit 580 receives the user's touch input selecting one of the plurality of set values of brightness C21, C22, C23, and C24, it can transmit to the robot cleaner 1 a control signal corresponding to information on the selected set value of brightness.

For example, as shown in FIG. 6, when the user touches the control screen and selects the set value of brightness as “50% C22”, the control unit 580 can transmit the control signal corresponding to the screen brightness of “50% C22” to the robot cleaner 1.

However, the plurality of set values of brightness C21, C22, C23, and C24 shown in FIG. 6 are examples, and a larger number of set values of brightness may be displayed, or a smaller number of set values of brightness may be displayed.

Alternatively, the plurality of set values of brightness C21, C22, C23, and C24 may be displayed as values representing the stages of screen brightness. For example, the set value of brightness displayed on the control screen may be “bright, normal, dark”.

In this way, as the control unit 580 of the external control device 5 displays a plurality of set values of brightness selectable by the user on the control screen, the user can easily adjust the screen brightness of the display means 171 to a desired brightness according to a situation.

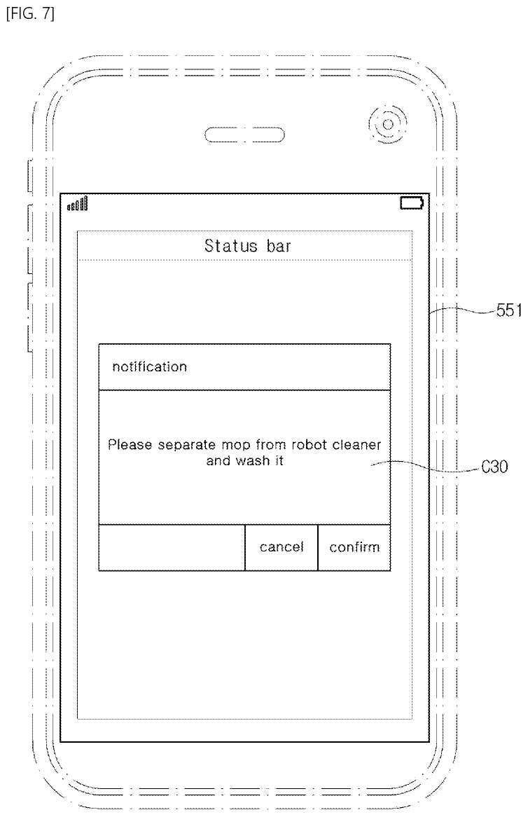

FIG. 7 is a view illustrating a control screen of an external control device that receives information on a washing notification from a robot cleaner.

As described above, the voice transmitting means 172 can transmits the mop washing notification, at the same time as the robot cleaner 1 enters the charging station, and retransmit it repeatedly at predetermined time interval (N hour).

In this case, as described above, the robot cleaner 1 retransmits the washing notification after transmitting the washing notification for the first time and the predetermined time elapses, and at the same time transmits information on the washing notification to the external control device 5.

When the wireless communication unit 510 of the external control device 5 receives the information on the washing notification, the control unit 580 may display a message guiding the mop washing notification on the control screen of the display unit 551 as a popup message C30.

For example, as shown in FIG. 7, the popup message C30 may include content to separate a mop from the robot cleaner 1 and wash the mop.

Through this, the user can not only audibly check the mop washing notification through the voice transmitting means 172 of the robot cleaner 1 but also visually check through the control screen of the external control device 5. Therefore, not only can the effect of drawing the user's attention be increased, but there is an advantage in that the user can receive the mop washing notification without missing it even if the user is visually impaired or hearing impaired.

In addition, when receiving the information on the washing notification, the control unit 580 may control the external control device 5 to generate vibration. The vibration may be generated through the haptic module 557 of the output unit 550. Through this, the user can tactilely check the mop washing notification.

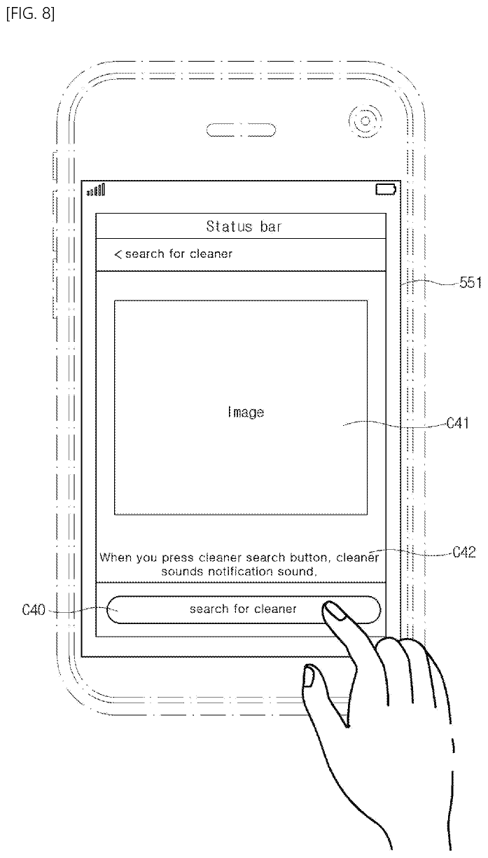

FIG. 8 is a view illustrating a control screen of an external control device for searching a current location of a robot cleaner.

Referring to FIG. 8, the control unit 580 may display a cleaner search item C40 for searching the current location of the robot cleaner 1 on the control screen. Also, the control unit 580 may display an image display area C41 and a message display area C42 on the upper portion of the search cleaner item C40.

For example, in the message display area C42, a message “If you press, the cleaner sounds a notification sound” may be displayed for guiding a corresponding function.

When receiving the user's touch input selecting the cleaner search item C40 on the control screen, the control unit 580 may transmit a control signal to the robot cleaner 1 to inquire about the location where the robot cleaner 1 stops. In addition, while inquiring about the location of the robot cleaner 1, it is possible to transmit a control signal for transmitting a warning sound from the voice transmitting means 172 of the robot cleaner 1. Also, when receiving the information on the location where the driving stops from the robot cleaner 1, the control unit may display it as an image on the control screen as the current location of the robot cleaner 1.

In this case, the current location of the robot cleaner 1 may be displayed on the image display area C41. Here, the current location of the robot cleaner 1 may be displayed as an image indicating the relative location of the robot cleaner 1 to the map, together with a map of the surface to be cleaned recognized while the robot cleaner is driving.

Accordingly, the user may visually recognize the location of the robot cleaner 1 from the image displayed on the image area C41 on the control screen, and aurally recognize the location of the robot cleaner 1 by listening the warning sound transmitted through the voice transmitting means 172 of the robot cleaner 1.

Lastly, the power supply unit 590 of the external control device 5 receives external power and internal power under the control of the control unit 580 to supply power required for the operation of each component.

Meanwhile, a block diagram of the control device 5 shown in FIG. 4 is a block diagram for an embodiment of the present invention. Each component in the block diagram may be integrated, added, or omitted according to the specifications of the actually implemented control device.

That is, two or more components may be combined into one component, or one component may be subdivided into two or more components as needed. In addition, the function performed by each block is for explaining the embodiment of the present invention, and the specific operation or device does not limit the scope of the present invention.

Hereinafter, a process in which the robot cleaner 1 of the present invention is controlled according to the type of the user input transmitted through the external control device 5 will be described in detail for each embodiment.

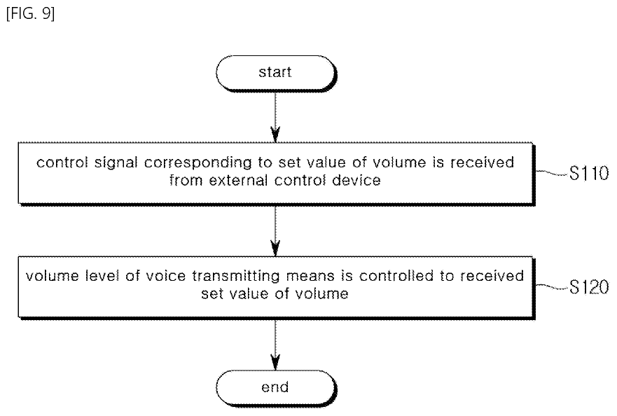

FIG. 9 is a flow chart showing a method of setting a volume level of a voice transmitting means in a robot cleaner.

Referring to FIG. 9, first, the communication unit 160 of the robot cleaner 1 receives a control signal corresponding to a set value of volume from the external control device 5 (S110).

Here, the set value of volume is the set value of volume selected by the user among a plurality of set values of volume through the control screen of the external control device 5.

Next, the control unit 110 receives the control signal and controls the volume level of the notification sound transmitted from the voice transmitting means 172 to the set value of volume selected by the user (S120).

For example, when the set value of volume selected by the user is “Normal C12” and the preset set value of volume in the voice transmitting means 172 is “Large C11”, the control unit 110 controls so that the level of the notification sound transmitted from the voice transmitting means 172 is smaller than the preset volume level.

Unlike the conventional suction-type robot cleaner, the robot cleaner having a wet mop function has a feature of low noise when performing the cleaning operation. Accordingly, the user may feel uncomfortable because the notification sound of the robot cleaner is relatively loud.

However, the robot cleaner of the present invention can remotely change the volume level transmitted from the robot cleaner by the user's input from the external control device, and thus, the user's inconvenience as described can be solved.

On the other hand, the notification sound to which the set value of volume selected by the user is applied may be configured to exclude a warning sound due to an error while the robot cleaner 1 is driving. Accordingly, it is possible to provide an effect of not missing an error warning of the robot cleaner 1 even when the user sets the set value of volume to be small.

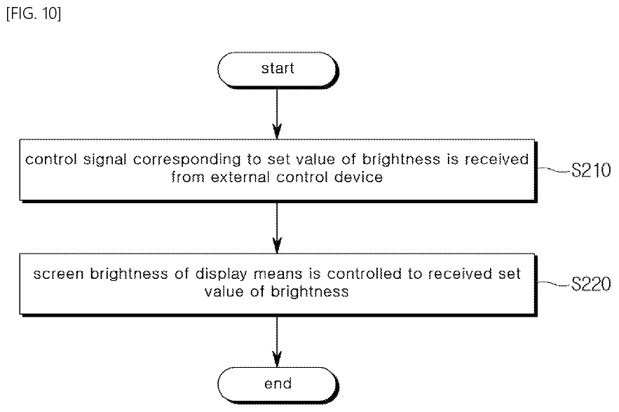

FIG. 10 is a flowchart illustrating a method of setting the screen brightness of a display means in a robot cleaner.

Referring to FIG. 10, first, the communication unit 160 of the robot cleaner 1 receives a control signal corresponding to the set value of brightness from the external control device 5 (S210).

Here, the set value of brightness is a set value of brightness selected by the user among a plurality of set values of brightness through the control screen of the external control device 5.

Next, the control unit 110 receives the control signal and controls the screen brightness of the display means 171 to the set value of brightness selected by the user (S220).

For example, when the set value of brightness selected by the user is “50% C22” and the preset set value of brightness in the display means 171 is “100% C24”, the control unit 110 controls the illuminance of the screen brightness of the display means 171 to be darkened by 50%.

While being charged in a charging station, light is illuminated from the display means 171 of the robot cleaner 1. For example, the light may be an LED light indicating a current battery level, reservation information, cleaning mode, etc., and since conventionally it is not possible to adjust the brightness of such an LED light, there is a problem that the user feels uncomfortable because the brightness of the LED light is brighter in the middle of the night than during the day.

However, the robot cleaner 1 of the present invention can remotely change the screen brightness of the display means 171 by the user's input from the external control device 5, and thus can solve the user's inconvenience described above.

In addition, it provides an effect of reducing power consumption by appropriately selecting the screen brightness of the display means 171.

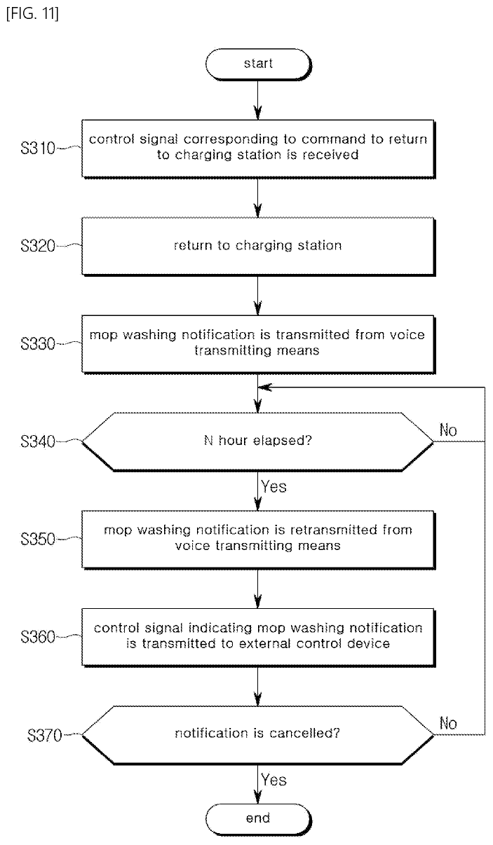

FIG. 11 is a flowchart illustrating a method for transmitting a mop washing notification by a robot cleaner.

Referring to FIG. 11, first, the robot cleaner receives a control signal corresponding to a command to return to a charging station (S310).

Here, the control signal corresponding to the command to return to a charging station may be remotely transmitted by the user input inputted by the user through the external control device 5. In this case, the communication unit 160 of the robot cleaner 1 receives the command to return to a charging station.

Alternatively, the command to return to a charging station may be transmitted by the user pressing the charging button included in the manipulation means 173.

Alternatively, the command to return to a charging station may be a control signal generated by the robot cleaner 1 to return to the charging station by itself after completing the cleaning operation. In this case, the control unit 110 of the robot cleaner 1 may generate the control signal.

Meanwhile, according to the control signal corresponding to the command to return to a charging station, the control unit 110 controls the robot cleaner 1 to return to the charging station, and when the robot cleaner 1 returns to the charging station (S320), the control unit 110 controls the voice transmitting means 172 to transmit the mop washing notification (S330).

In this case, the transmitted washing notification may be a voice message to guide the content to wash the mops 30, 40. Through this, the user's attention can be called to prevent the robot cleaner 1 from being left in a state with the contaminated mop attached after completing the cleaning operation.

The control unit 110 controls the voice transmitting means to retransmit the washing notification of the mops 30, 40 when a preset predetermined time elapses (S340) after the washing notification is first transmitted from the voice transmitting means 172 (S350).

For example, if the preset predetermined time is 1 hour, the washing notification is sent out at the same time as the robot cleaner 1 enters the charging station, and the washing notification is sent out again after 1 hour elapses thereafter.

Accordingly, the user can receive periodic guidance related to the mop washing, so that the robot cleaner can be hygienically managed.

Meanwhile, the control unit 110 may transmit the information on the washing notification to the external control device 5 (S360), at the same time as controlling the voice transmitting means 172 to retransmit the washing notification.

In this case, the information on the washing notification transmitted to the external control device 5 may be the control signal for displaying the mop washing notification as a message on the control screen of the external control device 5.

On the other hand, the control unit 110 repeatedly controls the washing notification to be transmitted from the voice transmitting means every predetermined time elapses until a release control signal for canceling the transmission of the washing notification is received from the user (S370).

In this case, the release control signal may be generated by, for example, an operation in which the user presses the power button included in the manipulation means 173 of the robot cleaner 1. Through this, the user can easily cancel the transmission of the washing notification, and it is possible to prevent the notification from continuously sending out and causing unnecessary noise.

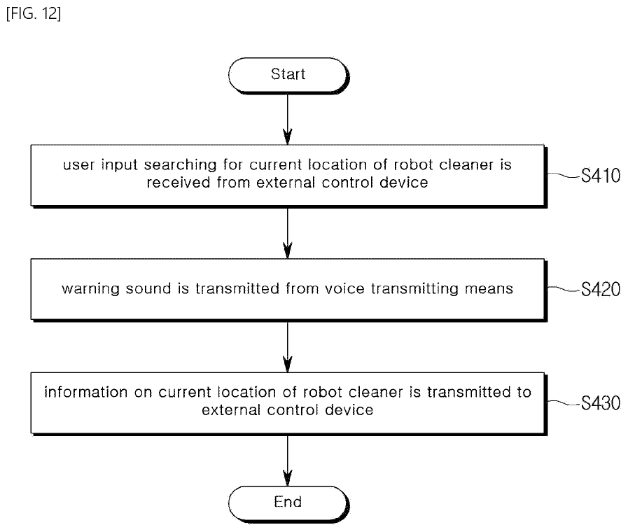

FIG. 12 is a flowchart illustrating a method in which a robot cleaner guides a current location of the robot cleaner to a user.

Referring to FIG. 12, first, the communication unit 160 of the robot cleaner 1 receives the user input searching the current location of the robot cleaner 1 from the external control device 5 (S410).

Here, the user input for searching for the current location of the robot cleaner 1 may be input by the user's touch input of the cleaner search item C40 through the control screen of the external control device 5.

The control unit 110 controls the voice transmitting means 172 to transmit a warning sound (S420).

In addition, the control unit 110 transmits information on the current location of the robot cleaner 1 to the external control device 5 at the same time as controlling the voice transmitting means 172 to transmit the warning sound (S430).

Here, the information on the current location of the robot cleaner 1 is the information on the location at which the robot cleaner 1 stops driving, it may be the information indicating the relative location of the robot cleaner 1 to the map, along with information on the map of the surface to be cleaned recognized while the robot cleaner 1 drives.

A conventional suction-type robot cleaner generates noise in the process of sucking dust, so that the current location of the robot cleaner can be easily recognized, but since the robot cleaner dedicated to the wet mop function has relatively little noise, it is difficult for the user to recognize which area of the surface to be cleaned is currently driven.

Accordingly, when the robot cleaner 1 stops driving due to an error or an obstacle while driving, there is a problem in that the user cannot easily search for the location of the robot cleaner 1.

However, according to the robot cleaner of the present invention, even when the robot cleaner 1 stops while driving, the user can easily detect the current location of the robot cleaner 1 remotely through the external control device.

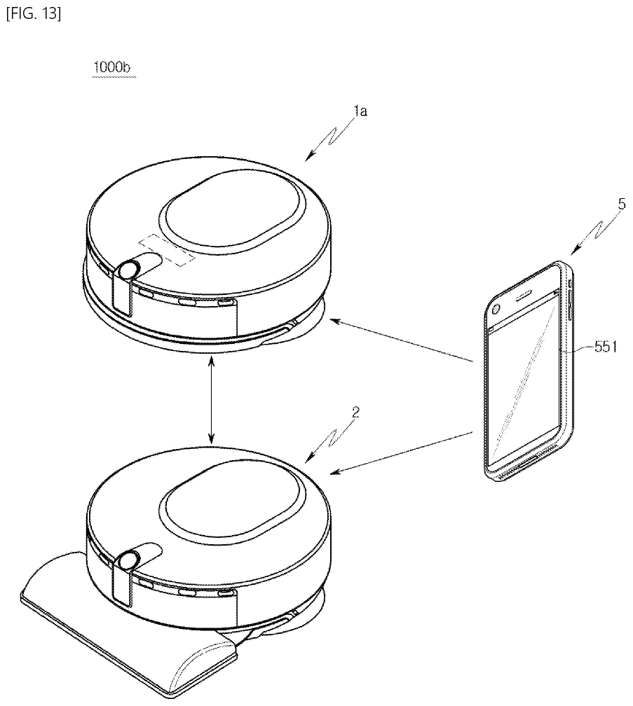

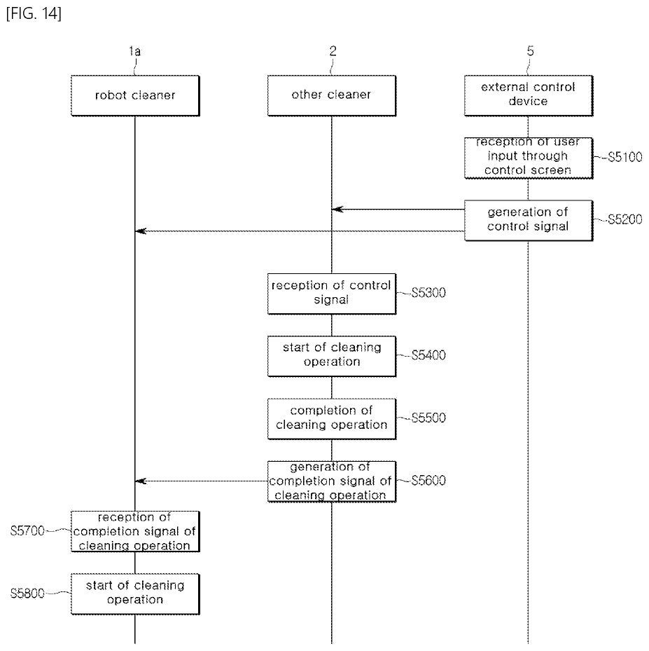

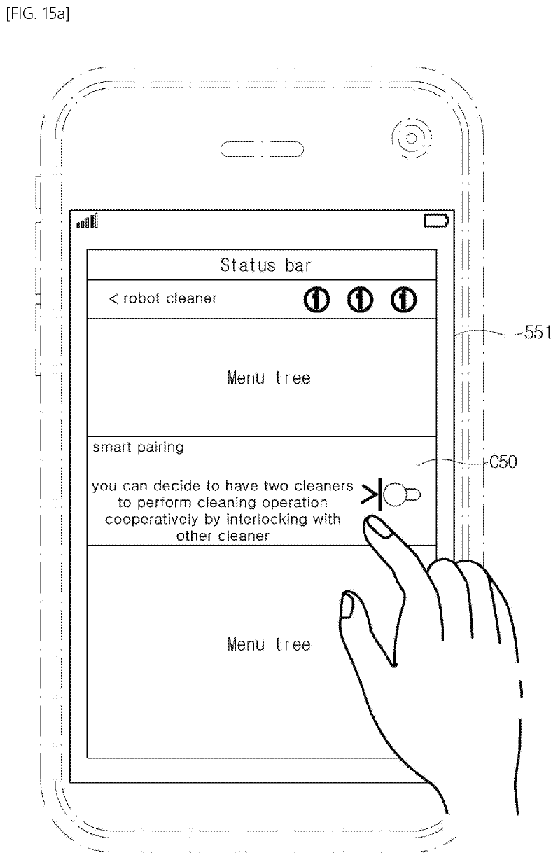

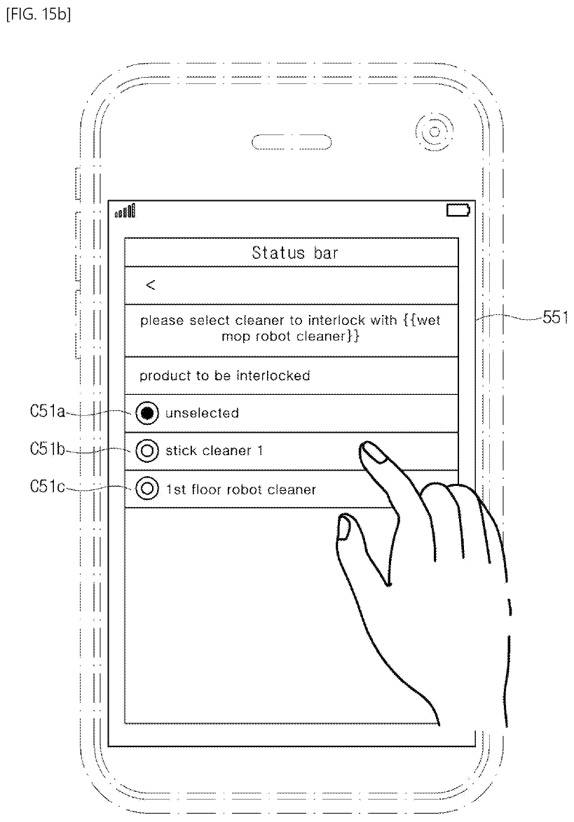

FIG. 13 is a conceptual view of a robot cleaning system according to another embodiment of the present invention, and FIG. 14 is a method of performing a cooperative cleaning operation in conjunction with another cleaner in the control method of the robot cleaning system according to another embodiment of the present invention. FIGS. 15a and 15b are views illustrating the control screen of the external control device for setting the cooperative cleaning operation in the robot cleaning system according to another embodiment of the present invention.

The robot cleaning system 1000b according to another embodiment of the present invention may include a robot cleaner 1a, other cleaner 2 to perform a cleaning operation in cooperation with the robot cleaner, and an external control device 5.

The robot cleaner 1a may have the same configuration as the robot cleaner 1 of the robot cleaning system 1000a according to an embodiment of the present invention. The other cleaner 2 may be a cleaner that performs a cleaning operation by sucking dust, a robot cleaner that drives autonomously, or a wired/wireless type stick cleaner operated by a user directly. The external control device 5 may have the same configuration as the external control device 5 of the robot cleaning system 1000a according to an embodiment of the present invention.

Referring to FIG. 13, the external control device 5 receives the user input selecting other robot cleaner 2 on the control screen (S5100).

Referring to FIG. 15a, an interlocking operation item C50 for cooperatively performing the cleaning operation by interlocking a plurality of cleaning periods may be displayed on the control screen of the external control device 5. When the external control device 5 receives the user input selecting the interlocking operation item C50, a screen for selecting an interlocking product may be displayed on the external control device 5.

Referring to FIG. 15b, the user may select a cleaner to be interlocked with the robot cleaner 1a among a plurality of registered cleaners C51a, C51b, and C51c displayed on the screen for selecting a product to be interlocked. For example, the user may select the stick cleaner 1 C51b.

The control unit 580 of the external control device 5 receives the user input selecting the other cleaner 2 and generates the control signal for interlocking a plurality of cleaning periods, and transmits it to the robot cleaner 1a and the selected other cleaner 2 (S5200).

In a state in which the other cleaner 2 interlocked with the robot cleaner 1a receives the control signal for interlocking the plurality of cleaning periods (S5300), when the cleaning operation is started (S5400) and the cleaning operation is completed (S5500), the other cleaner 2 generates the completion signal of the cleaning operation and transmits it to the robot cleaner 1a at the same time as completion of the cleaning operation (S5600).

When the robot cleaner 1a receives the completion signal of the cleaning operation transmitted by the other cleaner 2 through the communication unit 160 (S5700), the control unit 110 of the robot cleaner 1a controls the robot cleaner 1a to start the cleaning operation (S5800).

In this way, since the robot cleaner 1a can immediately perform the wet mop cleaning in conjunction with a plurality of cleaning periods after the cleaning operation for sucking dust is completed, the wet mop cleaning can be started without the user's separate control, so user convenience can be further increased.

As described above, the robot cleaner according to the present invention can change the volume level of the voice transmitting means to a desired level by adjusting the volume level of the voice transmitting means with the set value of volume set by the user through the external control device.

In addition, the robot cleaner according to the present invention can change the screen brightness of the display means to the brightness desired by the user by controlling the screen brightness of the display means with the set value of brightness set by the user through the external control device.

In addition, the robot cleaner according to the present invention is configured such that the mop washing notification is transmitted from the voice transmitting means and it is repeated at a predetermined time interval, so that the user may be advised periodically about the mop washing.

In addition, the robot cleaner according to the present invention is configured such that the warning sound is transmitted from the voice transmitting means when the user sends the control signal for searching for the current location of the robot cleaner through the external control device, so that the user can be informed of the current location of the robot cleaner.

Meanwhile, the block diagrams disclosed in the present disclosure may be interpreted by those of ordinary skill in the art as a form conceptually expressing a circuit for implementing the principles of the present disclosure. Similarly, it will be appreciated by those of ordinary skill in the art that any flow charts, flow diagrams, state transition diagrams, pseudocode, etc. may be represented substantially on a computer-readable medium, and represent a variety of processes that may be executed by such a computer or processor, whether or not explicitly shown.

Accordingly, the above-described embodiments of the present disclosure can be written in a program that can be executed on a computer, and can be implemented in a general-purpose digital computer operating the program using a computer-readable recording medium. The computer-readable recording medium may include a storage medium such as a magnetic storage medium (for example, a ROM, a floppy disk, a hard disk, etc.), an optically readable medium (for example, a CD-ROM, a DVD, etc.), and the like.

The functions of the various elements shown in the drawings may be provided through the use of dedicated hardware as well as hardware capable of executing software in association with appropriate software. When provided by a processor, such function may be provided by a single dedicated processor, a single shared processor, or a plurality of separate processors, some of which may be shared.

In addition, the explicit use of the terms “processor” or “control unit” should not be construed as referring exclusively to hardware capable of executing software, and without limitation, digital signal processor (DSP) hardware, read only memory (ROM) for storing software, random access memory (RAM), and non-volatile storage may be implicitly included.

In the foregoing, a specific embodiment of the present invention has been described and illustrated, but the present invention is not limited to the described embodiment, and it will be understood by those skilled in the art that various modifications and variations can be made in other specific embodiments without departing from the spirit and scope of the present invention.

Accordingly, the scope of the present invention should not be determined by the described embodiment, but should be determined by the technical idea described in the claims.

### DESCRIPTION OF REFERENCE NUMERALS

1000a, 1000b: robot cleaning system
1: robot cleaner
2: other cleaner
5: external control device
30: first mop
40: second mop
50: body
170: display unit
171: display means
172: voice transmitting means
173: manipulation means

1-11. (canceled)

12. A robot cleaner that cleans a surface while automatically driving, the robot cleaner comprising:
a body;
a mop coupled to the body; and
a display provided on the body, the display including:
a display screen coupled to an upper surface of the body, the display screen being configured to display a status of the robot cleaner; and
a speaker coupled to the body, the speaker being configured to output a sound,
wherein the display is controlled based on a control signal transmitted through an external control device.

13. The robot cleaner according to claim 12, wherein the speaker is set to a set volume level of the speaker, in response to the control signal corresponding to the set volume level of the speaker.

14. The robot cleaner according to claim 12, wherein a brightness of the display screen is set to a set value of brightness of the display screen, in response to the control signal corresponding to the set value of brightness of the display screen.

15. The robot cleaner according to claim 12, wherein the control signal is a command to return the robot cleaner to a charging station, and
wherein the speaker is controlled to output a washing notification of the mop, in response to the robot cleaner entering the charging station.

16. The robot cleaner according to claim 15, wherein the speaker is controlled to re-output the washing notification every time a preset predetermined time elapses after the washing notification is first transmitted.

17. The robot cleaner according to claim 12, wherein the speaker is controlled to transmit a warning sound when the control signal is received, in response to the control signal being a command to search for a current location of the robot cleaner.

18. A robot cleaning system comprising:
a robot cleaner configured to clean a surface while automatically driving, the robot cleaner including:
a body;
a display provided on the body, the display being configured to display information about the robot cleaner; and
an external control device configured to:
display a control screen,
generate a control signal based on a user input inputted through the control screen, and
transmit the control signal to the robot cleaner to control the display of the robot cleaner.

19. The robot cleaning system according to claim 18, wherein the external control device is configured to:
display a plurality of set values of volume on the control screen, and
transmit the control signal to the robot cleaner for controlling the robot cleaner to output sound at a selected set value of volume among the plurality of set values of volume, in response to the user input being the selected set value of volume.

20. The robot cleaning system according to claim 18, wherein the external control device is configured to:
display a plurality of set values of brightness on the control screen, and
transmit the control signal to the robot cleaner for controlling a screen brightness of the display to a selected set value of brightness among the plurality of set values of brightness, in response to the user input being the selected set value of brightness.

21. The robot cleaning system according to claim 18, wherein the external control device is configured to:
display a cleaner search item for searching a current location of the robot cleaner on the control screen, and
receive, from the robot cleaner, a location where the robot cleaner stops driving and display the location where the robot cleaner stops driving as the current location of the robot cleaner, in response to the user input being a selection of the cleaner search item, and
wherein the location where the robot cleaner stops driving is displayed as an image on the control screen.

22. The robot cleaning system according to claim 18, wherein the robot cleaner is a first robot cleaner,
wherein the robot cleaning system further includes a second robot cleaner configured to perform a cleaning operation in cooperation with the first robot cleaner, and
wherein the first robot cleaner receives a cleaning completion signal transmitted after the second robot cleaner completes a cleaning and the first robot cleaner starts a cleaning operation, in response to the external control device receiving the user input selecting the second robot cleaner on the control screen.

23. The robot cleaning system according to claim 18, wherein the robot cleaner is a first robot cleaner among a plurality of registered cleaners, and
wherein the external control device is configured to display a status bar including the plurality of registered cleaners.

24. The robot cleaning system according to claim 23, wherein the first robot cleaner and a second robot cleaner among the plurality of registered cleaners are interlocked, in response to the user input being a selection of the second robot cleaner on the external control device, and
wherein the first robot cleaner and the second robot cleaner are configured to cooperatively clean, in response to the first robot cleaner and the second robot cleaner being interlocked.

25. A robot cleaner that cleans a surface while automatically driving, the robot cleaner comprising:
a body;
a container detachably connected to the body;
a first mop coupled to the body, the mop being configured to:
receive fluid from the container, and
rotate; and
a display provided on the body, the display including a display screen coupled to an upper surface of the body, the display screen being configured to display content regarding a control signal transmitted from a user through an external control device.

26. The robot cleaner according to claim 25, wherein the display further includes a speaker coupled to the body, the speaker being configured to output a sound.

27. The robot cleaner according to claim 26, wherein the robot cleaner is configured to return to a charging station in response to the control signal being a command to return the robot cleaner to the charging station.

28. The robot cleaner according to claim 27, wherein the speaker is controlled to output a washing notification of the mop, in response to the robot cleaner entering the charging station.

29. The robot cleaner according to claim 28, wherein at a predetermined time after the washing notification is first transmitted, the speaker is controlled to re-output the washing notification, and the robot cleaner is configured to transmit the washing notification to the external control device.

30. The robot cleaner according to claim 29, wherein the robot cleaner includes a power button, and
wherein the transmission of the washing notification, by the robot cleaner, is canceled in response to the user pressing the power button.

31. The robot cleaner according to claim 25, further comprising a second mop connected to the body, the second mop being configured to:
receive the liquid from the container, and
rotate.
